(19) United States
(12) Patent Application Publication
(10) Pub. No.: US 2015/0145789 A1
(43) Pub. Date: May 28, 2015

(54) COORDINATE OUTPUT DEVICE, DISPLAY DEVICE, COORDINATE OUTPUT METHOD, AND PROGRAM

(71) Applicant: Sharp Kabushiki Kaisha, Osaka (JP)

(72) Inventors: Osamu Nishida, Osaka (JP); Teruhisa Masui, Osaka (JP); Masayuki Fujisawa, Osaka (JP)

(73) Assignee: Sharp Kabushiki Kaisha, Osaka (JP)

(21) Appl. No.: 14/403,095

(22) PCT Filed: Apr. 23, 2013
(86) PCT No.: PCT/JP2013/061944

§ 371 Date: Nov. 21, 2014

(30) Foreign Application Priority Data
May 28, 2012 (JP) 2012-120844

(51) Int. Cl. G06F 3/041; G02F 1/1333; G09G 3/36

(52) U.S. Cl. CPC G06F 3/0418; G06F 3/041; G09G 3/36; G02F 1/13338
USPC 345/173

(57) ABSTRACT

The present invention aims at reducing noise caused by driving of the display panel while reducing a drop in the output rate of coordinates representing an object to be drawn. A coordinate output device receives a horizontal synchronization signal of a display panel from a display panel control unit and starts to detect touch location on the touch panel after a prescribed length of time has passed from the initial rise of the horizontal synchronization signal. The coordinate output device detects coordinates representing touch location in accordance with a signal outputted from the touch panel and performs a generation process to generate coordinates based on three consecutive detected coordinates. The coordinate output device outputs coordinate data having the detected coordinates and the generated coordinates to a control unit as coordinates from a period when three of the generated coordinates were detected.

### TECHNICAL FIELD

The present invention relates to a coordinate output device, a display device, a method of outputting a coordinate, and a program. In particular, the present invention relates to a technique of generating coordinates in accordance with touch location on a touch panel.

### BACKGROUND ART

When a display device has a touch panel and a liquid crystal panel combined together, it is known that the voltage signals for driving the liquid crystal panel when a touch location has been detected on the touch panel causes noise. Therefore, in order reduce noise caused by driving of the liquid crystal panel, Japanese Patent Application Laid-Open Publication No. H10-124233 discloses a technique in which detection of touch location is performed synchronously with horizontal synchronization signals from the liquid crystal panel, and each frame period is divided into a display period and a detection period.

### SUMMARY OF THE INVENTION

In the conventional technique described above, noise caused by driving of the liquid crystal panel is reduced by detection of touch location being performed in accordance with the driving timing of the liquid crystal panel. The detection timing of touch location, however, is then limited to the driving timing of the liquid crystal panel. As a result, there are times when there is a drop in the output rate of coordinates to be drawn being outputted to the control device that causes displays images to be displayed on the display panel, and images that the user draws with a finger or the like are not properly displayed.

The present invention aims at proposing a technique that reduces the effects of noise caused by driving of the display panel while reducing a drop in the output rate of coordinates, which represent an object to be drawn.

A coordinate output device of the present invention includes a detection unit that causes the touch panel to output location information representing touch location during a detection period that starts after a prescribed length of time has passed in a display period of a display panel, thereby detecting a set of coordinates corresponding to touch location on the touch panel; a generation unit that performs a generation process to generate a set of coordinates in accordance with three sets of coordinates that have been detected by the detection unit; and an output unit that outputs coordinate data having the three sets of coordinates detected by the detection unit and the set of coordinates generated by the generation unit, the generated set of coordinates belonging to a period in which the three sets of coordinates were detected.

The coordinate output device of the present invention can reduce the effects of noise caused by driving of the display panel while reducing a drop in the output rate of coordinates, which represent an object to be drawn.

### BRIEF DESCRIPTION OF THE DRAWINGS

FIG. 1 is a block diagram showing a configuration example of a display device according to Embodiments 1 and 2.

FIG. 2 is a schematic view showing a touch panel, display panel, and backlight in Embodiments 1 and 2.

FIG. 3 is a view of a configuration example of the display panel according to Embodiments 1 and 2.

FIG. 4 is a view of functional blocks of a touch panel control unit and other elements in Embodiments 1 and 2.

FIG. 5 shows detection timing of the touch panel in Embodiments 1 and 2.

FIG. 6 is a view of a configuration example of the display panel according to Embodiments 1 and 2.

FIG. 7 is an operation flow chart of a coordinate output process of the display device according to Embodiment 1.

FIG. 8 is a view of detected coordinates in Embodiment 1.

FIG. 9 is a view for explaining a method of generating generated coordinates in Embodiment 1.

FIG. 10 is a view of the generated coordinates and detected coordinates in Embodiment 1.

FIG. 11 is a view of detected coordinates and generated coordinates in Embodiment 1.

FIG. 12 is an operation flow chart of a coordinate output process of the display device according to Embodiment 2.

FIG. 13 is a view of detected coordinates and a middle point (generated coordinate) based on the detected coordinates.

FIG. 14 is a view of detected coordinates and generated coordinates in Embodiment 2.

FIG. 15 is a view for explaining an example of a image drawn in Embodiment 2.

FIG. 16 is a view of generated coordinates when a fourth detected coordinate has been detected in Embodiment 2.

FIG. 17 is a view of generated coordinates in Modification Example 1.

FIG. 18 is a view of generated coordinates in Modification Example 4.

FIG. 19 is a view of generated coordinates in Modification Example 5.

### DETAILED DESCRIPTION OF EMBODIMENTS

A coordinate output device according to one embodiment of the present invention includes a detection unit that causes the touch panel to output location information representing touch location during a detection period that starts after a prescribed length of time has passed in a display period of a display panel, thereby detecting a set of coordinates corresponding to touch location on the touch panel; a generation unit that performs a generation process to generate a set of coordinates in accordance with three sets of coordinates that have been detected by the detection unit; and an output unit that outputs coordinate data having the three sets of coordinates detected by the detection unit and the set of coordinates generated by the generation unit, the generated set of coordinates belonging to a period in which the three sets of coordinates were detected (first configuration). With this configuration, it is possible to detect coordinates in which the effects of noise generated during the start of driving of the display panel have been reduced. Furthermore, coordinates are generated in accordance with the detected three coordinates, thereby allowing for a reduction in a drop of the output rate of the coordinates representing a picture to be drawn.

A second configuration of the present invention is the first configuration, wherein the generation unit may perform the generation process when two line segments formed by linking the detected three sets of coordinates in order of detection thereof are at an angle to each other that is within a prescribed angle range. With this configuration, it is possible to omit ineffectual generating processes and suitably display the images the user has drawn on the display panel.

A third configuration of the present invention is the first or second configuration, wherein the generation unit may perform the generation process when a length of respective line segments formed by linking the detected three sets of coordinates in order of detection thereof is at least a prescribed length. With this configuration, it is possible to omit ineffectual generating processes and suitably display the images the user has drawn on the display panel.

A fourth configuration of the present invention is any one of the first to third configurations, wherein the set of coordinates may be generated by substituting (x1, y1), (x2, y2), and (x3, y3) that respectively represent the detected three sets of coordinates into a formula below.

$$( x , y ) = ( \frac{- x 1 + 8 \cdot x 2 + 5 \cdot x 3}{12} , \frac{- y 1 + 8 \cdot y 2 + 5 \cdot y 3}{12} ) \qquad [ 1 ]$$

A fifth configuration of the present invention is any one of the first to third configurations, wherein the generation unit may generate midpoint coordinates representing midpoints of respective line segments that are formed by linking the detected three sets of coordinates in order of detection thereof, the set of coordinates generated by the generation unit being located inside a triangle that has the detected three sets of coordinates at respective tips thereof in accordance with the midpoint coordinates and the detected three sets of coordinates that are connecting points of the respective line segments, and wherein, among the detected three sets of coordinates, the output unit may output a first set of coordinates and the last set of coordinates thereof and the set of coordinates generated by the generation unit as the coordinate data.

A display device according to one embodiment of the present invention includes: a display panel configured to display an image; a touch panel that outputs location information representing a touch location in accordance with an input signal; the coordinate output device according to any one of the first to fifth configurations, the coordinate output device inputting the input signal to the touch panel and outputting coordinate data; and a display control unit that causes the display panel to display an image in accordance with the coordinate data outputted from the coordinate output device.

A method of outputting coordinates according to one embodiment of the present invention includes: causing the touch panel to output location information representing touch location during a detection period that starts after a prescribed length of time has passed in a display period of a display panel, thereby detecting a set of coordinates corresponding to touch location on the touch panel; generating a set of coordinates in accordance with three sets of coordinates that have been detected in the step of causing; and outputting coordinate data having the three sets of coordinates detected in the step of causing and the set of coordinates generated in the step of generating, the generated coordinates belonging to a period in which the three coordinates were detected.

A program according to one embodiment of the present invention causes a computer to perform the following: cause the touch panel to output location information representing touch location during a detection period that starts after a prescribed length of time has passed in a display period of a display panel, thereby detecting a set of coordinates corresponding to touch location on the touch panel; generate a set of coordinates in accordance with three sets of coordinates that have been detected in the step of causing; and output coordinate data having the three sets of coordinates detected in the step of causing and the set of coordinates generated in the step of generating, the generated coordinates belonging to a period in which the three coordinates were detected.

Specific embodiments of the present invention will be explained below with reference to figures. In the drawings referred to below, for ease of description, among the components of the embodiments of the present invention, only main members necessary for describing the present invention will be shown, in a simplified manner. Therefore, the display device of the present invention can include appropriate components not shown in the various drawings referred to in the present specification. Portions in the drawings that are the same or similar are assigned the same reference characters and descriptions thereof will not be repeated.

### Embodiment 1

### Configuration

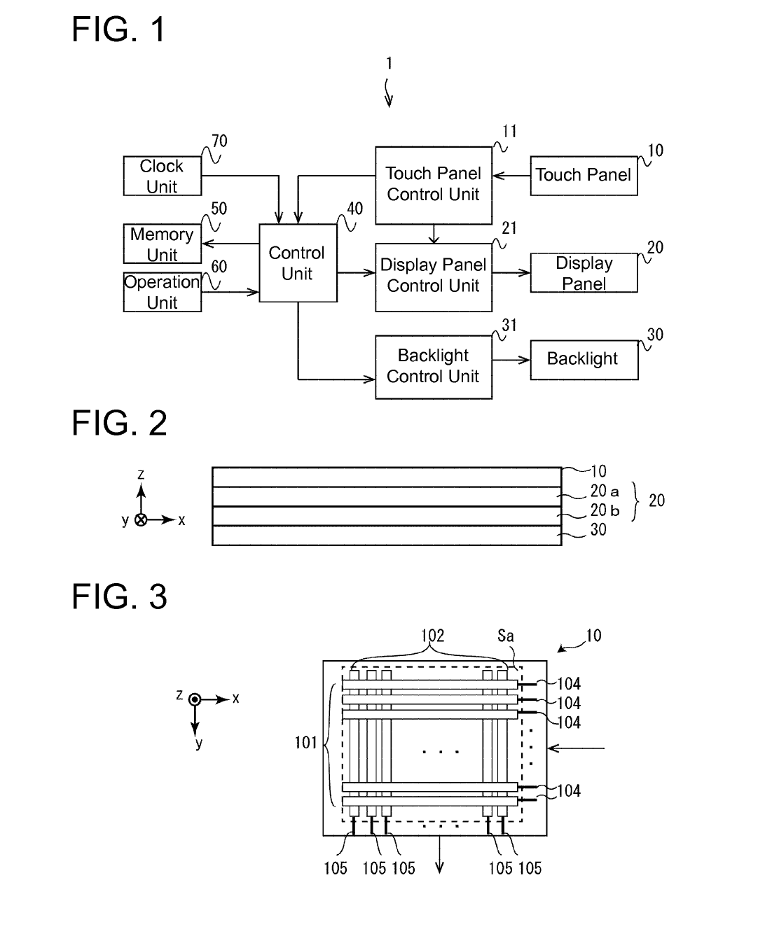

FIG. 1 is a block diagram showing a configuration example of a display device of Embodiment 1 of the present invention. As shown in FIG. 1, the display device 1 has a touch panel 10, a touch panel control unit 11, a display panel 20, a display panel control unit 21, a backlight 30, a backlight control unit 31, a control unit 40, a memory unit 50, an operation unit 60, and a clock unit 70. The touch panel 10, the display panel 20, and the backlight 30 are stacked as shown in FIG. 2.

The touch panel 10 functions as an input unit for receiving commands that a user makes through contact from a finger. FIG. 3 is a schematic view of the touch panel 10 from theZaxis direction in FIG. 2. The touch panel 10 is a capacitive type touch panel. The touch panel 10 has a sensing area Sa on the substrate, which is made of transmissive glass or the like. The sensing area Sa is an input area for receiving user operations and is disposed so as to overlap the display area on the display panel 20. A plurality of electrodes 101 and electrodes 102 are arrayed in the X direction and the Y direction, respectively, on this sensing area Sa. The plurality of electrodes 101 and electrodes 102 are made of a transmissive conductive material such as ITO (indium tin oxide). The touch panel 10 is electrically connected to the touch panel control unit 11, which is described later, through wiring lines 104 and wiring lines 105 respectively connected to the electrodes 101 and the electrodes 102. Under control of the touch panel control unit 11, if a voltage is sequentially applied to the electrodes 101 via the wiring lines 104, for example, a voltage value corresponding to the capacitance between the electrodes 101 and the electrodes 102 is outputted to the touch panel control unit 11 via the wiring lines 105.

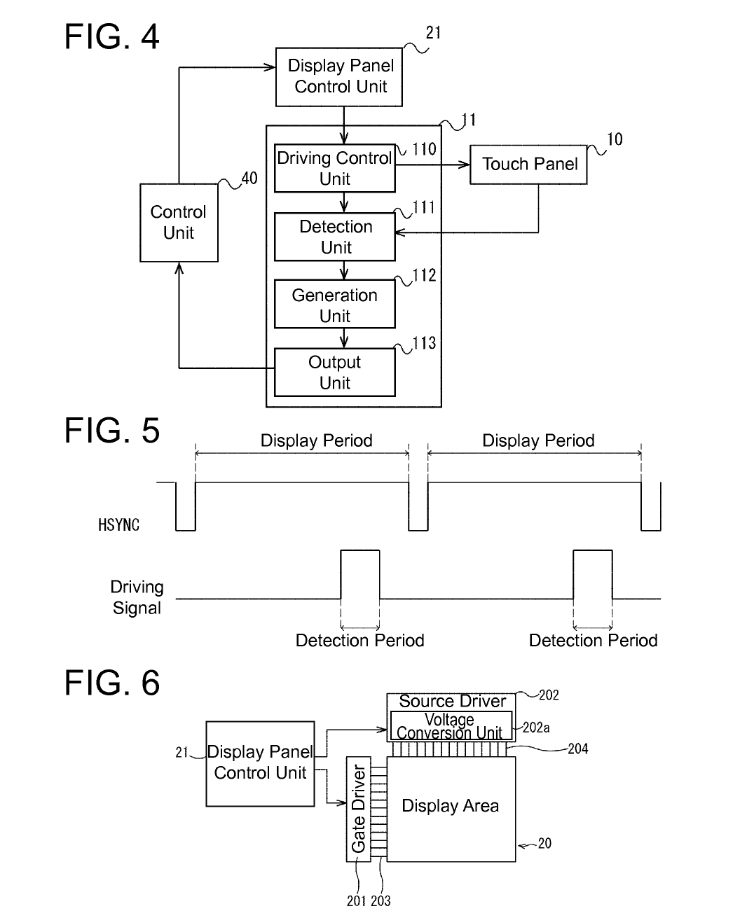

The explanation will be continued while referring back to FIG. 1. The touch panel control unit 11 has a CPU (central processing unit) (not shown), and a memory including a ROM (read only memory) and a RAM (random access memory). The touch panel control unit 11 performs a coordinate output process by the CPU running control programs stored in the ROM. FIG. 4 is a functional block view of the touch panel control unit 11, which runs the coordinate output process. The touch panel control unit 11 has a driving control unit 110, a detection unit 111, a generation unit 112, and an output unit 113. The functions of the respective units will be explained below.

The driving control unit 110 drives the touch panel 10 in accordance with horizontal synchronization signals from the display panel control unit 21. FIG. 5 is a view representing display of the display panel 20 and detection timing of the touch panel 10 in the present embodiment. As shown in FIG. 5, the horizontal synchronization signal becomes H-level during periods when an image is being displayed on the display panel, and becomes L-level during periods when no image is being displayed. After the start of the display period in which the horizontal synchronization signal becomes H-level, the driving control unit 110 outputs driving signals to the touch panel 10 at prescribed clock timing. Specifically, in the detection periods, the driving control unit 110 sequentially selects the electrodes 101 and applies a voltage thereto, and sequentially selects the electrodes 102. This outputs a voltage value corresponding to the capacitance between the selected electrodes 101 and electrodes 102 from the touch panel 10.

The detection unit 111 receives the voltage value outputted from the touch panel 10, or namely, the voltage value that corresponds to the combination of the electrodes 101 and the electrodes 102 selected by the driving control unit 110. The received voltage value is compared to a prescribed threshold. If the voltage value is at least the threshold, the coordinates corresponding to the location of the electrodes 101 and the electrodes 102 from where the voltage value was received are identified as coordinates expressing a touch location, and the identified coordinates (hereinafter, referred to as the detected coordinates) are chronologically stored in the RAM.

The generation unit 112 reads out the detected coordinates stored in the RAM in the order in which these coordinates have been detected, and generates coordinates in accordance with a prescribed arithmetic formula and the detected coordinates that have been read. The details of the method of generating these coordinates will be explained later in the operation explanation.

The output unit 113 outputs coordinate data that has the coordinates generated by the generation unit 112 (hereinafter referred to as generated coordinates) and the detected coordinates stored in the RAM to the control unit 40.

The explanation will be continued while referring back to FIG. 1. The display panel 20 is a transmissive liquid crystal panel in the present embodiment. The display panel 20 has an active matrix substrate 20b (FIG. 2) and an opposite substrate 20a (FIG. 2), and a liquid crystal layer (not shown) is sealed between the active matrix substrate 20b (FIG. 2) and the opposite substrate 20a (FIG. 2). The display panel 20 has a plurality of pixels (not shown) formed in a matrix shape by a plurality of gate lines 203 (FIG. 6) and a plurality of source lines 204 (FIG. 6) on the active matrix substrate 20b. These areas where the plurality of pixels are formed is the display area. A thin film transistor and a pixel electrode are provided for each pixel on the active matrix substrate 20. A common electrode and color filters that correspond in location to the respective pixels are provided on the opposite substrate 20a. The gate lines 203 (FIG. 6) are connected to the respective gate electrodes of the thin film transistors, and the source lines 204 (FIG. 6) are connected to the respective source electrodes.

FIG. 6 is a block view of the respective units connected to the display panel 20. The display panel control unit 21 has a CPU and a memory (ROM and RAM) (not shown). A gate driver 201 is connected to the plurality of gate lines 203, and transmits scan signals to the thin-film transistors through this plurality of gate lines 203. When the scan signals are inputted to the gate electrodes from the respective gate lines 203, the thin-film transistors are driven in accordance with the scan signals. A source driver 202 is connected to the source lines 204. Image data from the display panel control unit 21 is converted to a voltage signal by a voltage conversion unit 202a, and the source driver 202 transmits the voltage signal to the source lines 204 in accordance with the output timing of the scan signal from the gate driver 201. This causes liquid crystal molecules in the liquid crystal layer between the pixel electrodes and the common electrode to undergo a change in orientation state in accordance with the voltage signal, thereby controlling gradation of the respective pixels. As a result, an image corresponding to the image signal is displayed on the display panel 20.

The explanation will be continued while referring back to FIG. 1. The backlight 30 is disposed on the rear surface side of the display panel 20. The backlight 30 is a direct-lit backlight, for example, and has a plurality of light sources constituted of LEDs (light emitting diodes). The backlight control unit 31 has a CPU and a memory (ROM and RAM) (not shown). The backlight control unit 31, under control of the control unit 40, causes light to be emitted from the backlight 30 at a prescribed brightness.

The control unit 40 has a CPU and a memory (ROM and RAM). The control unit 40 controls the respective units connected thereto by the CPU running the control programs stored in the ROM. Specifically, the control unit 40 receives image data that includes operation signals from the operation unit 60 and detected coordinates and generated coordinates from the touch panel control unit 11, and then generates image data. The control unit 40 reads image data from the memory unit 50 and outputs an image signal having image data to the display panel control unit 21. The control unit 40 and the display panel control unit 21 are examples of a display control unit.

The memory unit 50 is a storage medium such as a hard disk, and stores various types of data such as application programs and image data operated by the display device 1. The operation unit 60 is operation keys such as a power switch of the display device 1, a menu button, and the like. The operation unit 60 outputs an operation signal representing content from user operation to the control unit 40. A clock unit 70 counts clock signals from a clock supplying unit (not shown).

(Operation)

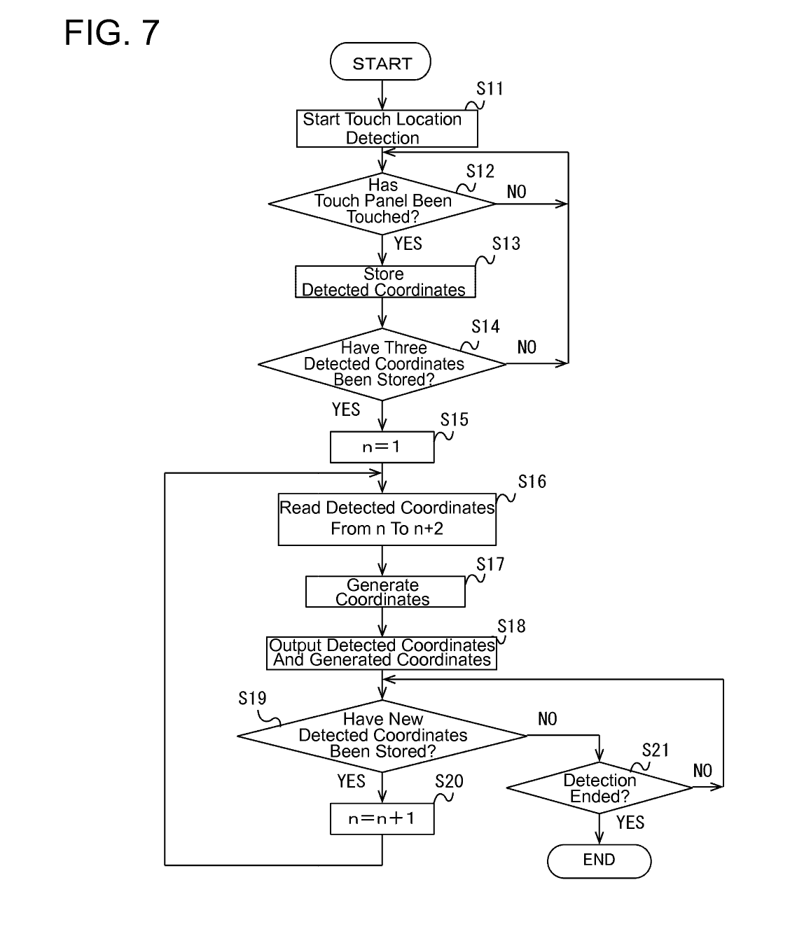

An example of operation of the coordinate output process in the display device 1 is explained below. FIG. 7 is a view of the operational flow of the display device 1. In the explanation below, the display panel control unit 21 drives the display panel 20 in accordance with horizontal synchronization signals, and the horizontal synchronization signals are transmitted to the touch panel control unit 11.

The touch panel control unit 11 detects touch location on the sensing area Sa at prescribed clock timing from the initial rise of the horizontal synchronization signal (step S11). Specifically, the touch panel control unit 11 sequentially selects the electrodes 101 of the touch panel 10 and applies a voltage thereto, and sequentially selects the electrodes 102. This causes a voltage value corresponding to the respective combinations of the electrodes 101 and the electrodes 102 to be consecutively outputted from the touch panel 10.

The touch panel control unit 11 determines whether or not the voltage value outputted from the touch panel 10 is at least a prescribed threshold, or namely, whether or not the touch panel 10 has been touched (step S12). If the voltage value is at least the prescribed threshold value (YES in step S12), the touch panel control unit 11 identifies the coordinates corresponding to the respective combinations of the electrodes 101 and the electrodes 102 for which the voltage value has been obtained as the touch location, and the identified detected coordinates are chronologically stored in the RAM (step S13). If the voltage value is not at least the prescribed threshold (NO in step S12), the touch panel control unit 11 repeats the process in step S12.

The touch panel control unit 11 repeats the processes up to and including step S12 until three detection coordinates are stored in the RAM (NO in step S14). If three detected coordinates (P1, P2, and P3) are stored in the RAM (YES in step S14), the touch panel control unit 11 sets a loop counter to n=1 (step S15), and reads out the three detected coordinates (P1, P2, and P3) from the RAM in order from number one to number three (step S16). The touch panel control unit 11 generates coordinates that are based on the three detected coordinates that have been read (step S17).

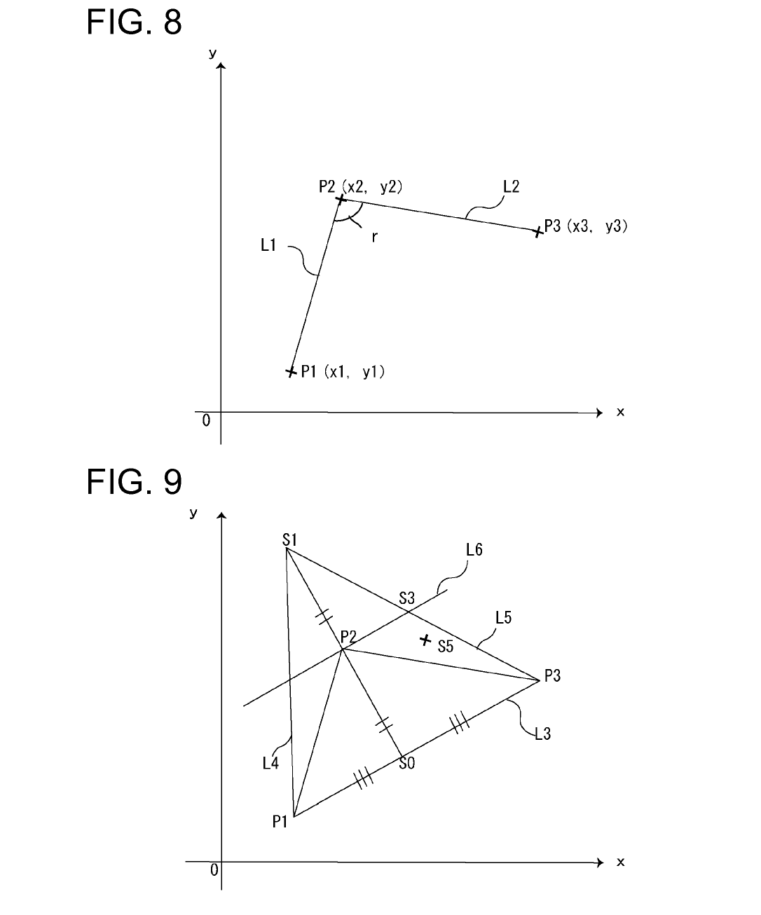

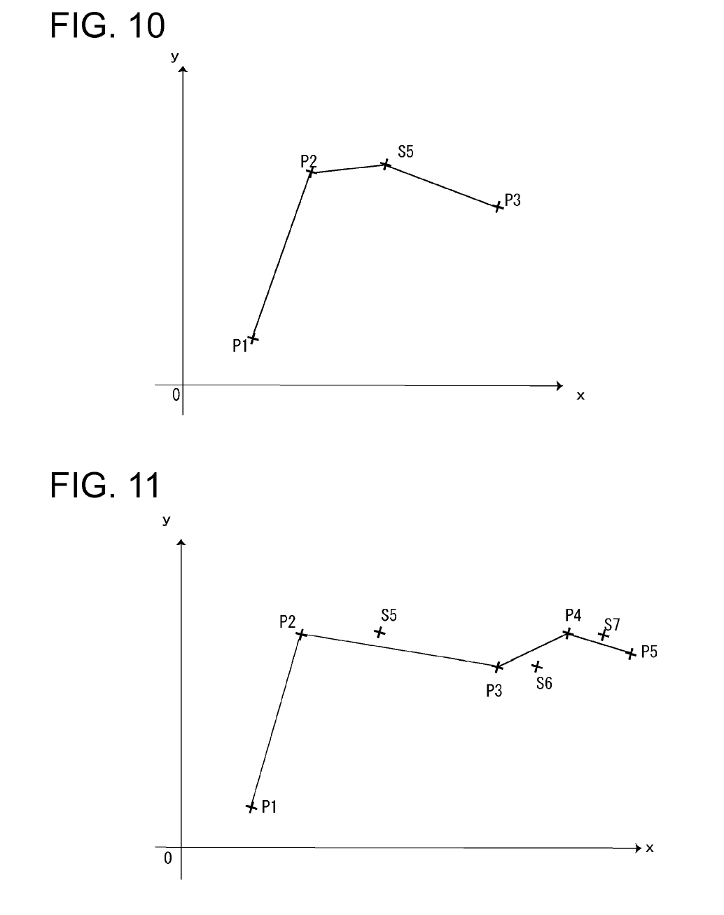

The process of the touch panel control unit 11 generating the coordinates that are based on the respective detected coordinates P1, P2, and P3 shown in FIG. 8 will be explained below with reference to FIG. 9.

(a) First, coordinates (xs0, ys0) at midpoint S0 on a line L3 connecting P1 to P3 are found using formula (1) below.

$$\begin{matrix}Formula ( 1 ) & \\ ( {x}_{s 0} , {y}_{s 0} ) = ( \frac{x 1 + x 3}{2} , \frac{y 1 + y 3}{2} ) & [ 2 ]\end{matrix}$$

Coordinates (xs1, ys1) at S1, which are symmetrical with point S0 that has been found in (a), are found using formula (2) below with point P2 as a reference.

$$\begin{matrix}Formula ( 2 ) & \\ ( {x}_{s 1} , {y}_{s 1} ) = ( \frac{2 \cdot x 2 - ( x 1 + x 3 )}{2} , \frac{2 \cdot y 2 - ( y 1 + y 3 )}{2} ) & [ 3 ]\end{matrix}$$

Coordinates (xs3, ys3) at S3, which is at the intersection of line L5 connecting P3 to S1 and linear line L6, which is parallel to the line L3, are found using formula (3) below.

$$\begin{matrix}Formula ( 3 ) & \\ ( {x}_{s 3} , {y}_{s 3} ) = ( \frac{- x 1 + 4 \cdot x 2 + x 3}{4} , \frac{- y 1 + 4 \cdot y 2 + y 3}{2} ) & [ 4 ]\end{matrix}$$

(d) Coordinates (xs5, ys5) at S5, which is the centroid of a triangle having P2, P3, and S3 at the tips thereof, is found using formula (4) below.

$$\begin{matrix}Formula ( 4 ) & \\ ( {x}_{s 5} , {y}_{s 5} ) = ( \frac{- x 1 + 8 \cdot x 2 + 5 \cdot x 3}{12} , \frac{- y 1 + 8 \cdot y 2 + 5 \cdot y 3}{12} ) & [ 5 ]\end{matrix}$$

(e) The coordinates of S5, which are found in (d) as described above, are the generated coordinates that are based on P1, P2, and P3.

In this manner, the generated coordinates S5 are generated, and these coordinates are located on the outside of a triangle having the three detected coordinates P1, P2, and P3 at the tips thereof.

The explanation will be continued while referring back to FIG. 7. The touch panel control unit 11 sets the generated coordinates (S5) as the coordinates of the period in which the three detected coordinates (P1, P2, and P3) were detected, and outputs coordinate data including the detected coordinates (P1, P2, and P3) and the generated coordinates (S5) to the control unit 40 (step S18). If new detection coordinates are stored in the RAM (YES in step S19), the touch panel control unit 11 increase the loop counter by 1 (step S20), and repeats the processes up to and including step S16 described above. When detection coordinates used to generate a second set of generated coordinates are to be outputted, the first two detected coordinates out of the three detected coordinates used in the generation of the previous set of generated coordinates may not need to be outputted; i.e., only the last detected set of coordinates may be outputted.

In step S19, if new detection coordinates have not been stored in the RAM (NO in step S19), then the touch panel control unit 11 repeats the processes in the steps up to and including step S20 if the detection period has not ended yet (NO in step S21). If the detection period has ended (yes in step S21), then the coordinate output process is ended. An example was described in which the generated coordinates (S5) are generated using the formula (1) to (4) above, but the generated coordinates (S5) may be found by substituting the respective coordinates of the detected coordinates P1, P2, and P3 in formula (4).

FIG. 10 is a view of a curved line displayed on the display panel 20, and this curved line is based on the generated coordinates (S5) and the detected coordinates (P1, P2, and P3) outputted to the control unit 40 by the display panel control unit 21. As shown in FIG. 10, the generated coordinates (S5) are located outside of a triangle having P1, P2, and P3 at the tips thereof.

As shown in FIG. 11, if detected coordinates P4 and P5 are sequentially stored in the RAM following P3, then when P4 is stored, S6 will be generated based on P2, P3, and P4, in a manner similar to the above generation process. Thereafter, the generated coordinates (S6) and the detected coordinates (P3) are outputted as coordinate data. When P5 is stored, S7 will be generated based on P3, P4, and P5, and then the generated coordinates (S7) and the detected coordinates (P4) will be outputted as coordinate data. In this case, the generated coordinates (S6 and S7) are located on the outside of the triangle having P2, P3, and P4 at the tips thereof and the triangle having P3, P4, and P5 at the tips thereof, respectively.

In Embodiment 1 described above, detection of touch location on the touch panel 10 is performed after a certain period of time has passed from the start of driving of the display panel 20. Therefore, detection of the touch panel 10 can be performed without being affected by noise generated during the start of the driving of the display panel 20. In Embodiment 1 described above, the three detected coordinates that were detected in the detection period of the touch panel 10 can be substituted into a simple arithmetic formula to generate coordinates. Therefore, it is possible to increase the output rate of coordinates without significantly increasing the processing load for generating coordinates.

### Embodiment 2

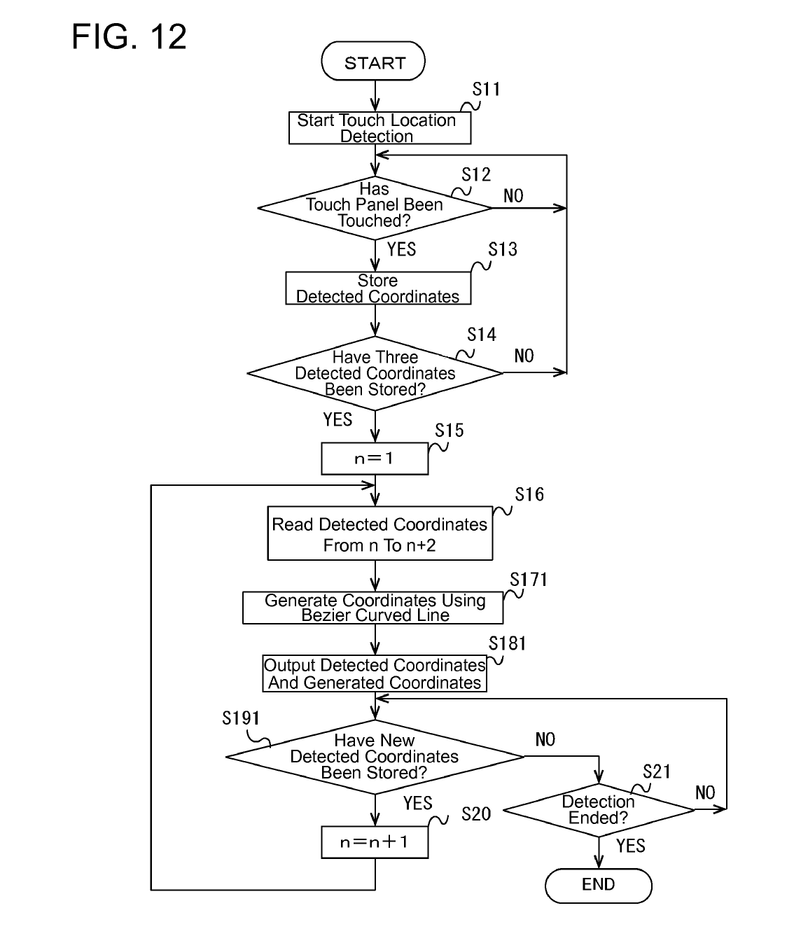

Next, an example of coordinate generation that is different from Embodiment 1 will be explained. Elements that are shared with Embodiment 1 will be given the same reference characters as Embodiment 1, and parts that are different from Embodiment 1 will be explained using FIGS. 12 to 16.

FIG. 12 is an operational flow of an example of a coordinate output process in the present embodiment. In the explanation below, detected coordinates P1, P2, and P3 are sequentially detected and then stored in the RAM in a touch panel control unit 11, in a manner similar to the example in Embodiment 1 (FIG. 8).

The touch panel control unit 11 reads the detected coordinates P1, P2, and P3 from the RAM (YES in step S14, then S15 and S161) and generates coordinates using a Bezier curve based on these detected coordinates (step S171). The method of generating the coordinates is as follows.

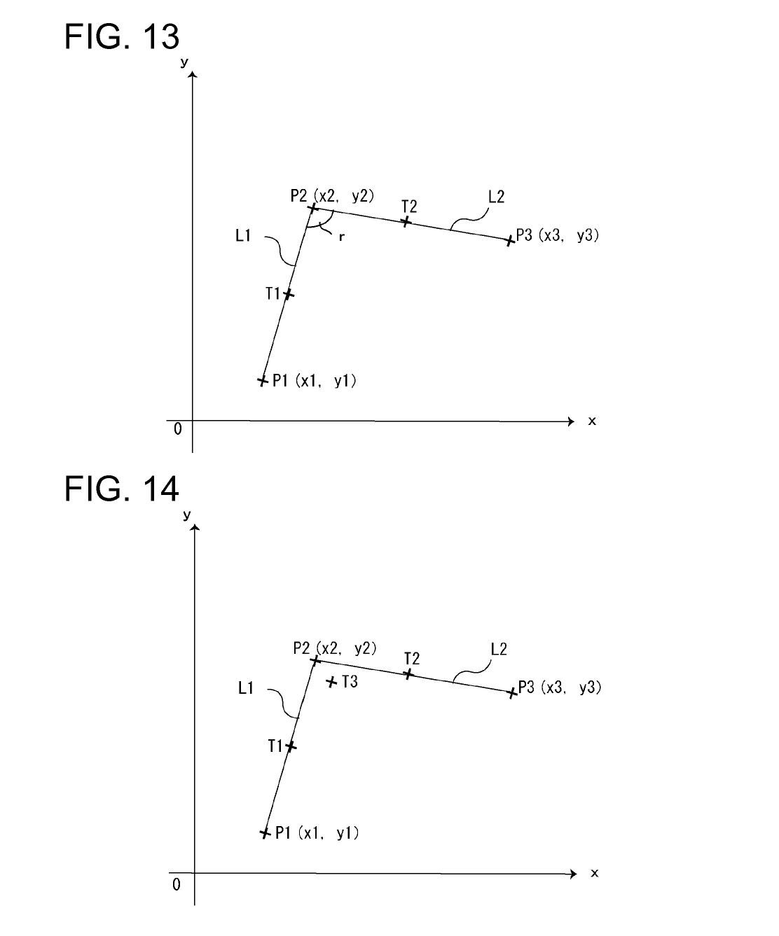

(a) As shown in FIG. 13, the touch panel control unit 11 finds midpoint T1 between P1 and P2 and midpoint T2 between P2 and P3 using formulae (5) and (6) below.

$$\begin{matrix}[ 6 ] & \\ ( {x}_{T 1} , {y}_{T 1} ) = ( \frac{x 1 + x 2}{2} , \frac{y 1 + y 2}{2} ) & Formula ( 5 ) \\ ( {x}_{T 2} , {y}_{T 2} ) = ( \frac{x 2 + x 3}{2} , \frac{y 2 + y 3}{2} ) & Formula ( 6 )\end{matrix}$$

(b) Next, the touch panel control unit 11 generates T3 coordinates (xT3, yT3) shown in FIG. 14 by using the two-dimensional Bezier curve, the midpoints T1 and T2, and the detected coordinates P2. Specifically, ½ is substituted for parameter (t) of the two-dimensional Bezier curve P(t) to obtain formula (7) below. The respective xy coordinates of T1, P2, and T3 are substituted into P0, P1, and P2 in formula (7) to find the xy coordinates of T3 found in formulae (8) and (9) below.

$$\begin{matrix}[ 7 ] & \\ \begin{matrix}P ( t ) = {( 1 - t )}^{2} \cdot {P}_{0} + 2 ( 1 - t ) \cdot {P}_{1} + {t}^{2} \cdot {P}_{2} \\ = \frac{{P}_{0}}{4} + \frac{{P}_{1}}{2} + \frac{{P}_{3}}{4}\end{matrix} & Formula ( 7 ) \\ \begin{matrix}{x}_{T 3} = ( \frac{x 1 + x 2}{2} ) \frac{1}{4} + \frac{x 2}{2} + ( \frac{x 2 + x 3}{2} ) \frac{1}{4} \\ = \frac{x 1 + 6 \cdot x 2 + x 3}{8}\end{matrix} & Formula ( 8 ) \\ \begin{matrix}{y}_{T 3} = ( \frac{y 1 + y 2}{2} ) \frac{1}{4} + \frac{y 2}{2} + ( \frac{y 2 + y 3}{2} ) \frac{1}{4} \\ = \frac{y 1 + 6 \cdot y 2 + y 3}{8}\end{matrix} & Formula ( 9 )\end{matrix}$$

The explanation will be continued while referring back to FIG. 12. The touch panel control unit 11 sets the generated coordinates (T1, T2, and T3) generated in step S17 as the coordinates from when the detected coordinates (P1, P2, and P3) were detected, and outputs the detected coordinates (P1 and P3) and the generated coordinates (T1, T2, and T3) to the control unit 40 (step S191).

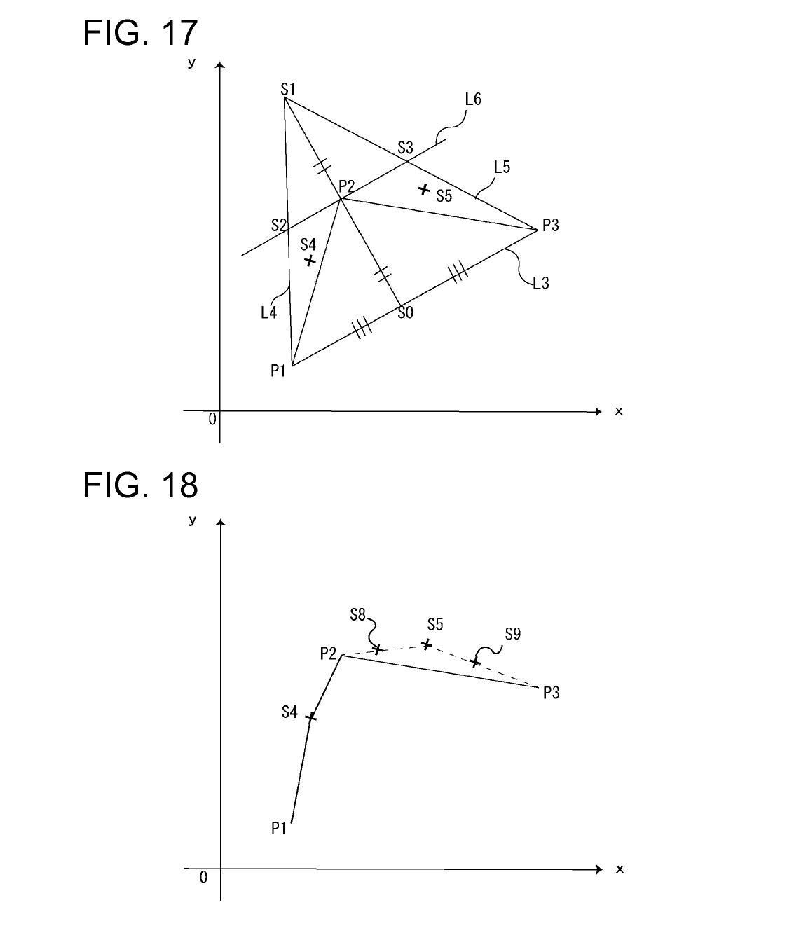

After the detected coordinates P3 are stored, if new detected coordinates P4 are stored in the RAM (YES in step S191), then the touch panel control unit 11 increases the loop counter by 1 and reads out the detected coordinates P2, P3, and P4 (step S21, step S161), and repeats the processes up to and including step S171. As shown in FIG. 16, in this case, this generates generated coordinates T5 that are based on the midpoint T2 of P2 and P3, P3, and the midpoint T4 between P3 and P4. In the second set of processes in step S191, the new detected coordinates and the generated coordinates may be outputted as coordinate data so as not to overlap with the previous set of detected coordinates and generated coordinates, or the detected coordinates used for generating the generated coordinates and all of the generated coordinates may be outputted as coordinate data.

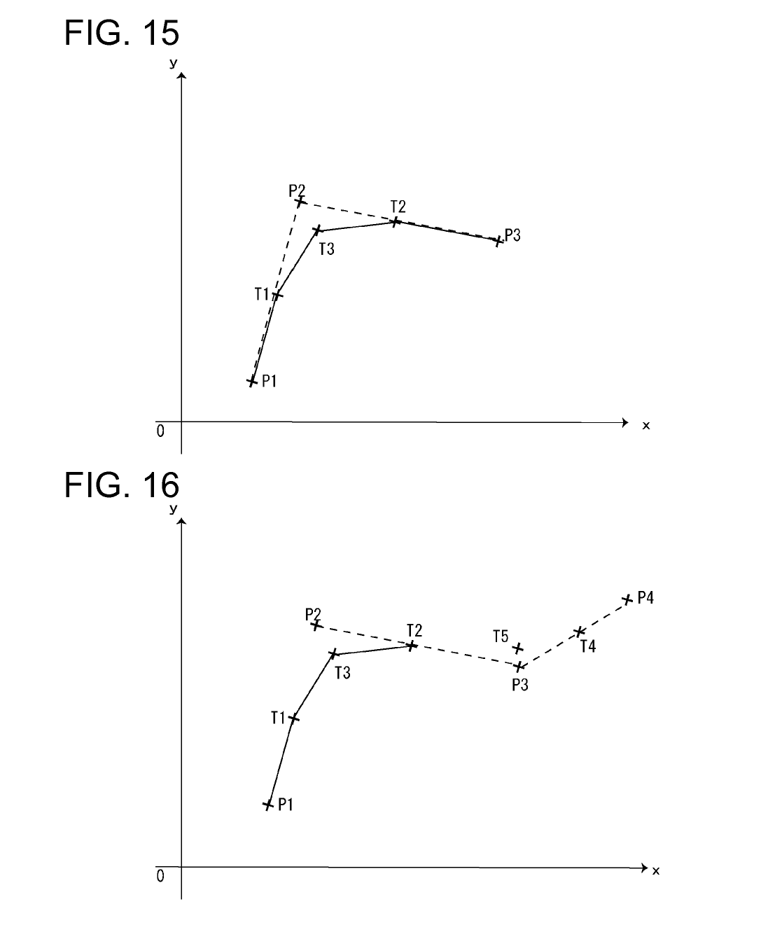

In the example described above, the solid line image shown in FIG. 15 is displayed on the display panel 20 by the display panel control unit 21 on the basis of the generated coordinates (T1, T2, and T3) and the detected coordinates (P1 and P3) outputted to the control unit 40. As shown in FIG. 15, in the present embodiment, the generated coordinates T3 are located inside the triangle having the detected coordinates P1, P2, and P3 at the tips thereof. As a result, a curved line is drawn that is smoother than when the generation process is not performed (the dotted line).

In Embodiment 2 described above, detection of touch location is performed after a certain period of time has passed from the start of the display period of the display panel 20, in a manner similar to Embodiment 1, thereby making it possible to obtain detection coordinates having reduced noise during driving of the display panel 20. Furthermore, the three detected coordinates that have been detected are substituted into a two-dimensional Bezier curved line formula to find generated coordinates; therefore, it is possible to reduce a drop of the coordinate output rate without significantly increasing the processing load.

### Modification Example

The embodiments of the present invention were described above, but the present invention is not limited to the embodiments above, and modification examples and combinations of modification examples below are also included in the scope of the present invention.

(1) In Embodiment 1, an example was described in which, of the three detected coordinates, coordinates are generated between the final detected coordinates and the detected coordinates before these coordinates (hereinafter, referred to as the middle detected coordinates), and no coordinates were generated between the first detected coordinates and the middle detected coordinates, but coordinates may be generated between the first detected coordinates and the middle detected coordinates. Specific examples (i) and (ii) thereof will be explained below.

(i) In the example in FIG. 8, if the three detected coordinates P1, P2, and P3 are stored in the RAM, then in addition to S5 and as shown in FIG. 17, S4 may be generated as a coordinate between P1 and P2, with S4 being at the centroid of a triangle having detected coordinates P1 and P2 and the intersection S2 of linear line L6 and line L4 at the tips thereof. In this case, the coordinates (xs2, ys2) of the intersection S2 are found using formula (10) below. The coordinates (xs4, ys4) of S4 are found using formula (11) below.

$$\begin{matrix}[ 8 ] & \\ ( {x}_{s 2} , {y}_{s 2} ) = ( \frac{x 1 + 4 \cdot x 2 - x 3}{4} , \frac{y 1 + 4 \cdot y 2 - y 3}{2 } ) & Formula ( 10 ) \\ ( {x}_{s 4} , {y}_{s 4} ) = ( \frac{5 \cdot x 1 + 8 \cdot x 2 - x 3}{12} , \frac{5 \cdot y 1 + 8 \cdot y 2 - y 3}{12 } ) & Formula ( 11 )\end{matrix}$$

(ii) In the example shown in FIG. 8, when the two detected coordinates P1 and P2 are stored in the RAM, coordinates may be generated by using coordinates P1 and P2 and formula (4). Specifically, the coordinates of P1 are substituted into (x1, y1) and (x2, y2) and the coordinates of P2 are substituted into (x3, y3) in formula (4). In other words, the coordinates of P1 are used twice to generate coordinates.

In (i) above, it is necessary for formula (10) for generating S4 to be stored in addition to formula (4) and for a process to be run separately from formula (4). In the configuration in (ii), the coordinates can be generated with just formula (4), thus allowing for memory capacity and processing load to be more reduced than the configuration in (i). In the configuration in (i), the coordinates of S4 are not generated until the three detected coordinates of P1, P2, and P3 are stored. Accordingly, in the configuration in (i), after the coordinates of S4 are generated, the detected coordinates (P1, P2, and P3), and the generated coordinates (S4 and S5) are outputted. Meanwhile, in the configuration in (ii), the coordinates of S4 are generated when the detected coordinates of P1 and P2 have been stored. Accordingly, in the configuration in (ii), after the coordinates of S4 have been generated, the detected coordinates (P1 and P2) and the generated coordinates (S4) are outputted, and after the S5 coordinates have been generated, the detected coordinates (P3) and the generated coordinates (S5) are outputted. Therefore, in the configuration in (ii), it is possible to output the coordinates and draw a picture faster than in the configuration in (i).

(2) In Embodiments 1 and 2 described above, the touch panel control unit 11 may generate coordinates when the conditions below are met. The coordinates may be generated when an angle r based on the three detected coordinates is within a prescribed angle range, for example. In other words, when the three detected coordinates P1 (x1, y1), P2 (x2, y2), and P3 (x3, y3) shown in FIG. 8, for example, are sequentially detected and then stored in the RAM, coordinates are generated when the angle r of the two lines L1 and line L2, which are formed by P1, P2, and P3 being linked together in order of detection, is within any prescribed angle range (under 90°, for example).

As another example, the generated coordinates may be generated when the respective two lines linking the three detected coordinates together in order of detection are at least a prescribed length (at least five dots, for example), or the coordinates may be generated when the total length of the two lines is at least a prescribed length (at least ten dots, for example).

Alternatively, in addition to the angle and length based on the three detected coordinates, the coordinate generation process may be performed when an operation that instructs generation of the coordinates is performed. The coordinate generation process may be performed when conditions combining any of the respective conditions above are met.

(3) In the example in Embodiment 2 described above, during the second set of coordinate generation, the detected coordinates P2, P3, and P4 are read to generate coordinates, but coordinates may be generated based on the generated coordinates T2 and the detected coordinates P3 and P4 that were previously generated.

(4) In Embodiment 1 and Modification Example 1 described above, as shown in FIG. 18, coordinates S8 between P2 and S5, and coordinates S9 between S5 and P3 may be generated by using detected coordinates P2, generated coordinates S5, and detected coordinates P3, for example. In other words, further coordinates may be generated by using the two detected coordinates and the generated coordinates between these detected coordinates. In this case, it is possible to find the coordinates of S9 by substituting the respective coordinates of P2, S5, and P3 into formula (4) described above. Furthermore, S8 may be found by substituting the respective coordinates of P2, S5, and P3 into formulae (10) and (11) above, in a manner similar to Modification Example 1, or S8 may be found by substituting the coordinates of P2 and S5 into formula (4) above, in a manner similar to (ii) of Modification Example 1.

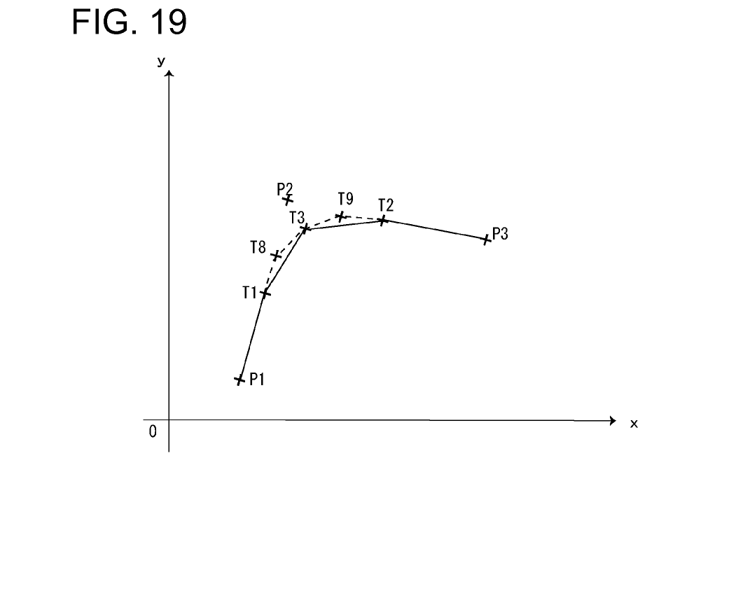

(5) In Embodiment 2 described above, various coordinates may be further generated between the detected coordinates P1 and the generated coordinates T1, and between the detected coordinates P3 and the generated coordinates T2. In this case, the respective coordinates of T1, P2, and T2 are substituted into P0, P1, and P2 in the respective formulae in which ¼ and ¾ have been respectively configured for the parameter (t) in formula (7). The formulae for finding generated coordinates S8 (xT8, yT8) and S9 (xT9, yT9) for t=¼ and t=¾ are shown below. FIG. 19 is a view of T8 and T9, which are found by the formulae below in the example in FIG. 15. As shown in FIG. 19, T8 and T9 are located inside a triangle having P1, P2, and P3 at the tips thereof, in a manner similar to T3. These generated coordinates and detected coordinates P1 and P3 make it possible to draw the curved line smoother than in Embodiment 2.

xT8=(9×x1+22×x2+x3)/32

yT8=(9×y1+22×y2×y3)/32

xT9=(x1+22×x2+9×x3)/32

yT9=(y1+22×y2+9×y3)/32

(6) In Embodiments 1 and 2 described above, an example was shown in which coordinate generation is performed in the touch panel control unit 11, but the detected coordinates may be outputted to the control unit 40 from the touch panel control unit 11 and coordinate generation may be performed in the control unit 40.

(7) In Embodiments 1 and 2 described above, the display device 1 was described as an example, but a coordinate output device that has the functions of the touch panel control unit 11 may be provided separately. In other words, the coordinate output device may receive detection results from the touch panel 10 and generate detected coordinates and generated coordinates based on these detection results, or may receive detected coordinates based on detection results of the touch panel 10 from another device and then generate coordinates and output coordinate data.

### INDUSTRIAL APPLICABILITY

The present invention can be applied to the industry of display devices equipped with touch panels.

1. A touch panel coordinate output device, comprising a touch panel control unit configured to:
cause the touch panel to output location information representing touch location during a detection period that starts after a prescribed length of time has passed in a display period of a display panel, thereby detecting a set of coordinates corresponding to touch location on the touch panel;
perform a generation process to generate a set of coordinates in accordance with three sets of coordinates that have been detected; and
output the generated set of coordinates as coordinate data from the touch panel.

2. The touch panel coordinate output device according to claim 1, wherein the generation process is performed when two line segments formed by linking the detected three sets of coordinates in order of detection thereof are at an angle to each other that is within a prescribed angle range.

3. The touch panel coordinate output device according to claim 1, wherein the generation process is performed when a length of respective line segments formed by linking the detected three sets of coordinates in order of detection thereof is at least a prescribed length.

4. The touch panel coordinate output device according to claim 1, wherein the set of coordinates is generated by substituting (x1, y1), (x2, y2), and (x3, y3) that respectively represent the detected three sets of coordinates into a formula below.
$$( x , y ) = ( \frac{- x 1 + 8 \cdot x 2 + 5 \cdot x 3}{12} , \frac{- y 1 + 8 \cdot y 2 + 5 \cdot y 3}{12 } )$$

5. The touch panel coordinate output device according to claim 1,
wherein the touch panel control unit generates midpoint coordinates representing midpoints of respective line segments that are formed by linking the detected three sets of coordinates in order of detection thereof, the set of coordinates generated by the touch panel control unit being located inside a triangle that has the detected three sets of coordinates at respective tips thereof in accordance with the midpoint coordinates and the detected three sets of coordinates that are connecting points of the respective line segments, and
wherein, among the detected three sets of coordinates, the touch panel control unit outputs a first set of coordinates and the last set of coordinates thereof and the generated set of coordinates as the coordinate data.

6. A display device, comprising:
a display panel configured to display an image;
a touch panel that outputs location information representing a touch location in accordance with an input signal;
the touch panel coordinate output device according to claim 1, said touch panel coordinate output device inputting the input signal to the touch panel and outputting coordinate data; and
a display control unit that causes the display panel to display an image in accordance with the coordinate data outputted from the coordinate output device.

7. A method of outputting coordinates, comprising:
causing the touch panel to output location information representing touch location during a detection period that starts after a prescribed length of time has passed in a display period of a display panel, thereby detecting a set of coordinates corresponding to touch location on the touch panel;
generating a set of coordinates in accordance with three sets of coordinates that have been detected in the step of causing; and
outputting the set of coordinates generated in the step of generating as coordinate data from the touch panel.

8. A non-transitory storage medium that stores instructions executable by a computer, said instructions causing the computer to perform the following:
cause the touch panel to output location information representing touch location during a detection period that starts after a prescribed length of time has passed in a display period of a display panel, thereby detecting a set of coordinates corresponding to touch location on the touch panel;
generate a set of coordinates in accordance with three sets of coordinates that have been detected; and
output the set of generated coordinates as coordinate data from the touch panel.

9. The touch panel coordinate output device according to claim 2, wherein the generation unit performs the generation process is performed when a length of respective line segments formed by linking the detected three sets of coordinates in order of detection thereof is at least a prescribed length.

10. The touch panel coordinate output device according to claim 2, wherein the set of coordinates is generated by substituting (x1, y1), (x2, y2), and (x3, y3) that respectively represent the detected three sets of coordinates into a formula below.
$$( x , y ) = ( \frac{- x 1 + 8 \cdot x 2 + 5 \cdot x 3}{12} , \frac{- y 1 + 8 \cdot y 2 + 5 \cdot y 3}{12 } )$$

11. The touch panel coordinate output device according to claim 3, wherein the set of coordinates is generated by substituting (x1, y1), (x2, y2), and (x3, y3) that respectively represent the detected three sets of coordinates into a formula below.
$$( x , y ) = ( \frac{- x 1 + 8 \cdot x 2 + 5 \cdot x 3}{12} , \frac{- y 1 + 8 \cdot y 2 + 5 \cdot y 3}{12 } )$$

12. The touch panel coordinate output device according to claim 9, wherein the set of coordinates is generated by substituting (x1, y1), (x2, y2), and (x3, y3) that respectively represent the detected three sets of coordinates into a formula below.
$$( x , y ) = ( \frac{- x 1 + 8 \cdot x 2 + 5 \cdot x 3}{12} , \frac{- y 1 + 8 \cdot y 2 + 5 \cdot y 3}{12 } )$$

13. The touch panel coordinate output device according claim 2,
wherein the touch panel control unit generates midpoint coordinates representing midpoints of respective line segments that are formed by linking the detected three sets of coordinates in order of detection thereof, the set of coordinates generated by the touch panel control unit being located inside a triangle that has the detected three sets of coordinates at respective tips thereof in accordance with the midpoint coordinates and the detected three sets of coordinates that are connecting points of the respective line segments, and
wherein, among the detected three sets of coordinates, the touch panel control unit outputs a first set of coordinates and the last set of coordinates thereof and the generated set of coordinates as the coordinate data.

14. The touch panel coordinate output device according claim 3,
wherein the touch panel control unit generates midpoint coordinates representing midpoints of respective line segments that are formed by linking the detected three sets of coordinates in order of detection thereof, the set of coordinates generated by the touch panel control unit being located inside a triangle that has the detected three sets of coordinates at respective tips thereof in accordance with the midpoint coordinates and the detected three sets of coordinates that are connecting points of the respective line segments, and
wherein, among the detected three sets of coordinates, the touch panel control unit outputs a first set of coordinates and the last set of coordinates thereof and the generated set of coordinates as the coordinate data.

15. The touch panel coordinate output device according claim 11,
wherein the touch panel control unit generates midpoint coordinates representing midpoints of respective line segments that are formed by linking the detected three sets of coordinates in order of detection thereof, the set of coordinates generated by the touch panel control unit being located inside a triangle that has the detected three sets of coordinates at respective tips thereof in accordance with the midpoint coordinates and the detected three sets of coordinates that are connecting points of the respective line segments, and
wherein, among the detected three sets of coordinates, the touch panel control unit outputs a first set of coordinates and the last set of coordinates thereof and the generated set of coordinates as the coordinate data.

16. The touch panel coordinate output device according claim 12,
wherein the touch panel control unit generates midpoint coordinates representing midpoints of respective line segments that are formed by linking the detected three sets of coordinates in order of detection thereof, the set of coordinates generated by the touch panel control unit being located inside a triangle that has the detected three sets of coordinates at respective tips thereof in accordance with the midpoint coordinates and the detected three sets of coordinates that are connecting points of the respective line segments, and
wherein, among the detected three sets of coordinates, the touch panel control unit outputs a first set of coordinates and the last set of coordinates thereof and the generated set of coordinates as the coordinate data.
